(19) United States
(12) Patent Application Publication
(10) Pub. No.: US 2018/0060457 A1
(43) Pub. Date: Mar. 1, 2018

(54) METHOD AND SYSTEM FOR COMPARING BLOCK DIAGRAMS

(71) Applicant: dSPACE digital signal processing and control engineering GmbH, Paderborn (DE)

(72) Inventors: Ulf HOMANN, Paderborn (DE); Michael KNAUP, Paderborn (DE)

(73) Assignee: dSPACE digital signal processing and control engineering GmbH, Paderborn (DE)

(21) Appl. No.: 15/249,737

(22) Filed: Aug. 29, 2016

(51) Int. Cl. G06F 17/50

(52) U.S. Cl. CPC G06F 17/509

(57) ABSTRACT

A computer-implemented method for comparing block diagrams, the block diagrams describing a temporal evolution and/or internal states of a dynamic system in a technical computing environment on a host computer, wherein a block in the block diagram may comprise input ports for receiving signals and output ports for sending signals. The method includes opening a first block diagram, converting the first block diagram to an intermediate form, the conversion comprising filtering using a filter script, opening a second block diagram, converting the second block diagram to an intermediate form, the conversion comprising filtering using a filter script, determining existing differences between the intermediate form of the first block diagram and the intermediate form of the second block diagram, and outputting the determined differences. Also, a non-transitory computer readable media and computer system is provided.

### BACKGROUND OF THE INVENTION

### Field of the Invention

The present invention relates to methods and computer systems for comparing block diagrams, the block diagram describing a temporal evolution and/or an internal states of a dynamic system.

### Description of the Background Art

Electronic control units (ECUs) are ubiquitous especially in automotive applications; generally, they may contain a processor, in particular a microcontroller, one or more sensor interfaces and one or more circuits to control an actuator. Current parameters of a physical process are preferably determined using the signals of the one or more sensors connected to the sensor interfaces. Based on a predefined control strategy, the processor may control the one or more circuits to apply the actuators and thus influence the physical process. In an example, an ECU may be used to perform anti-lock braking, with a sensor measuring the wheel velocity and a magnetic valve reducing the pressure in the corresponding wheel brake.

In order to speed up the development process for ECUs, control strategies are increasingly developed using block diagrams in a technical computing environment (abbreviated as TCE), which advantageously allows for tracing the temporal evolution of a dynamic system by simulation. Block diagrams are a graphical representation of the dynamic system to be simulated, preferably comprising blocks representing operations or elements of the system and lines representing signals that are exchanged between different blocks. One or more blocks in the block diagram may model the physical process to be controlled, and one or more blocks in the block diagram may model the control system. One particular example of a TCE is MATLAB/Simulink of The MathWorks.

During the development process, models may be shared, exchanged and iteratively refined by several persons in order to more closely show the desired behavior when test stimuli are applied to the system. As a result, a plurality of different versions of a block diagram and/or a plurality of different block diagrams may exist for one dynamic system. Different block diagrams may differ in the general structure i.e. the layout of the blocks and signals, so that many differences exist. Different versions of a block diagram may have the same general structure, but one or more parameters of one or more blocks are changed, so that only few differences exist even for large block diagrams. U.S. Pat. No. 5,974,254 discloses a computer-implemented method for detecting differences between a first and a second graphical program, wherein the detected differences are displayed on a computer screen.

Models in block diagrams may not only be used to create control strategies, but they also may be used to describe a dynamical system for simulation purposes, such as in a hardware-in-the-loop simulation. It is also in these applications that different block diagrams may be created which need to be compared.

When a block diagram contains a large number of blocks, e.g. because of the complexity of the modeled dynamic system, the number of differences between two block diagrams may render it prohibitively difficult to find those differences that are currently of interest for the user. Thus, it is desirable to provide for a more flexible method of determining differences between two block diagrams.

### SUMMARY OF THE INVENTION

It is therefore an object of the present invention to provide a method and computer system for comparing block diagrams.

In an exemplary embodiment of the invention, computer-implemented methods for comparing block diagrams are provided. The block diagrams describe a temporal evolution and/or internal states of a dynamic system in a technical computing environment on a host computer, wherein a block in the block diagram may comprise input ports for receiving signals and output ports for sending signals. The method can comprise the steps of: opening a first block diagram; converting the first block diagram to an intermediate form, the conversion comprising filtering using a filter script; opening a second block diagram; converting the second block diagram to an intermediate form, the conversion comprising filtering using a filter script; determining existing differences between the intermediate form of the first block diagram and the intermediate form of the second block diagram, and outputting the determined differences.

The steps of the inventive methods may be carried out by a processor running different software components on the host computer, the software components preferably using mechanisms of the technical computing environment or mechanisms of the operating system of the host computer to exchange data and/or cause the execution of one or more further software components. The processor of the host computer may be a single general-purpose microprocessor or the host computer may comprise a plurality of general-purpose and/or application-specific processor cores; the cores may be implemented using a programmable logic element such as an FPGA.

The host computer may be realized as a single standard computer comprising a processor, a display device and an input device. Alternatively, the host computer may comprise or be connected to one or more servers comprising one or more processing elements, the servers being connected to a client comprising a display device and an input device via a network. In this setup, the technical computing environment may be executed partially or completely on a remote server, such as in a cloud computing setup. A graphical user interface of the technical computing environment may be displayed on a portable computing device, in particular a computing device with a touch screen interface or with a virtual reality interface. In this case, it is particularly advantageous when the computations for executing the block diagram are carried out on a remote server with comparably high computing power.

The technical computing environment may comprise a graphical user interface for modifying the block diagram and a simulation engine for executing the block diagram, so that the dynamical system described by the block diagram can be simulated. The block diagram may comprise multiple blocks with input and/or output signals that are connected to output and/or input signals of other blocks. Each block may be an atomic functional unit or may be composed of a plurality of subordinate blocks. Preferably, one or more blocks of the block diagram model the desired behavior or intended functionality of the control program. Other blocks may for instance represent test input stimuli for the modeled control program or a plant model connected to the modeled control system in order to provide a closed control loop. Blocks may be connected via signals in order to exchange data; signals may be real or complex and be composed to N-dimensional vectors or buses. Block diagrams may comprise blocks for describing internal states of a dynamic system and elements for describing transitions between the internal states. In particular, a block diagram may be composed of or comprise a statechart.

The term filter script may be intended to encompass any scripts that transform information, i.e. it is not to be confined to reducing or discarding information. A filter script may e.g. convert information into a more user-friendly or readable form. This may include e.g. reformatting and/or translating textual information contained in or related to the model. The word filtering is used to stress that these transformations may be adapted to the human perception as opposed to conversions that may be adapted to make the block diagram readable by a different program or software component.

The intermediate form of a block diagram may be similar to the original form of the block diagram, but preferably comprises information on block libraries used in creating the model and/or information on parameter values from a workspace or a data definition tool used in creating the model. For example, the intermediate form differs from the original form of a block diagram at least in that one or more blocks and/or parameters are removed from the block diagram. A block diagram may be stored in a file on a storage medium of the host computer, in particular a mass storage system comprising a hard disk. Opening a block diagram may comprise loading the contents of the file in a memory of the host computer. For example, the file may be a compressed or uncompressed file in a first markup language that comprises information on the blocks and the signals in the block diagram. According to an embodiment of the invention, the intermediate form of a block diagram may be a file, for example, an uncompressed file, in a second markup language that comprises information on the blocks and the signals in the block diagram. The second markup language can be adapted to describe additional parameters of the block diagram, such as information on block libraries used in creating the model and/or information on parameter values from a workspace or a data definition tool used in creating the model. The second markup language may be similar to the first markup language. When the block diagram is stored in a compressed file in a first markup language, the intermediate form may be an uncompressed file in the first markup language. Generally, the intermediate form need not be stored as a file on a storage medium, but the intermediate form may only be present in the memory of the host computer or in a server database.

The inventive method allows for a highly selective isolation of desired differences from general information that currently constitutes unimportant “noise”. Because the filtering is implemented in the form of filter scripts, complex transformations or filter patterns may be designed by way of an iterative refinement. Further, a filter script may be easily reused e.g. by copying it and adapting a few lines of the script or by using sub-scripts. By using scripts, more diverse functionalities can be performed than via a fixed filter pattern. The script language may e.g. be adapted for mathematical calculations. Any element or parameter of the block diagram may be transformed or discarded using filter scripts. Advantageously, the intermediate form may have reduced memory requirements because the amount of information to be stored may be considerably reduced.

According to an embodiment of the invention, filtering using a filter script comprises discarding at least one block and/or at least one parameter of a block diagram, so that the block and/or the parameter are not present in the intermediate form of the block diagram. A parameter may be a property of the block or of an element in the block. Thus, an intermediate form produced by the inventive method may have reduced storage space and memory requirements comparing to an unfiltered form of the block diagram; additionally, the computation time for determining differences may be reduced. Alternatively or additionally, one or more parameter of a block diagram may be displayed in a different form, e.g. to improve readability.

Generally, a filter script may remove information, in particular elements of the block diagram or parameters relevant to the execution of the block diagram in the simulation engine. Alternatively or additionally, a filter script may also retrieve additional information, e.g. from a data definition tool or from the simulation environment for executing block diagrams. When information is stored in an external storage like a file or a database, parts of the additional information may be included in the intermediate form of the block diagram. Further, a filter script may transform collected information for the intermediate form. When the filter script is executed by a script interpreter of the technical computing environment, accessing information from the different software components in the technical computing environment is particularly easy.

According to an embodiment of the invention, outputting the determined differences comprises outputting an indication of all the filter scripts used for filtering and/or an indication of a version of the filter scripts used for filtering and/or an indication of the applied rules or modifications. The indications may be outputted directly via a display, generated to a report (log file) or they may be added to the intermediate form, so that the information on the applied filtering is preserved. For each element, e.g. block, in the block diagram, it may be indicated if the information on the element in the intermediate form was modified by a filter script. If more than one filter script is used, the indication of the applied rules or modifications may comprise an indication which element in the block diagram was modified by which filter script. An indication of the filter scripts used for filtering may also comprise information on a current version of the filter scripts. In particular, detailed indications concerning the modifications may be incorporated in the intermediate form, whereas general information such as a list of the applied filter scripts may be added to a detailed report (log file) and/or directly displayed to the user via a user interface on the display of the host computer and/or may be stored in a data management system.

In an embodiment of the invention, the technical computing environment comprises a modeling environment and a script interpreter, opening a block diagram comprises invoking the modeling environment of the technical computing environment, and filtering a block diagram using a filter script comprises executing the filter script in the script interpreter of the technical computing environment.

In an embodiment of the invention, the intermediate form of a block diagram can be a file in a markup language that comprises information on the blocks and the signals in the block diagram, converting a block diagram comprises evaluating the value of at least one parameter in the modeling environment and/or the script interpreter, and the intermediate form of the block diagram also comprises the value of the at least one parameter. A markup language may be a text-based language that comprises tags holding additional or meta-information such as indications of sections and relations between at least some of the sections. Preferably, the markup language complies with the XML (Extensible Markup Language) standard.

When a block diagram comprises multiple hierarchical levels, wherein a block in a first hierarchical level may be implemented using plurality of blocks in a second hierarchical level, wherein the second hierarchical level is below the first hierarchical level, in particularly directly below the first hierarchical level, the inventive method preferably comprises filtering using a filter script comprises selecting a hierarchical level and/or limiting the number of hierarchical levels which are converted in the intermediate form. In particular, blocks in the first hierarchical level may be kept and blocks in the second hierarchical level may be discarded when filtering the block diagram using a filter script. A block diagram may comprise atomic blocks and/or subsystems and/or referenced models. An atomic block may receive a signal and/or perform a computation, such as an addition, but does not possess a lower hierarchical level comprising a plurality of blocks implementing the functionality of the block.

Outputting the determined differences can comprise displaying a graphical diagram and/or at least one line of text containing at least some of the determined differences, and the outputting is performed using a display and/or a network interface and/or a storage medium of the host computer. Outputting the determined differences may comprise generating a report, in particular as a text file, e.g. a PDF file. The report may also comprise a screenshot displaying one or more blocks of the block diagram.

The inventive method may further comprise copying at least one block from the first block diagram to the second block diagram based on the determined differences and/or deleting at least one block from the second block diagram based on the determined differences. Based on the outputted differences, the first and the second block diagram may be merged by copying or deleting at least one element, such as a block or a parameter, in order to reduce the number of determined differences. Generally, the process of merging the first and the second block diagram may comprise copying one or more first blocks from the first block diagram to the second block diagram as well as copying one or more second blocks from the second block diagram to the first block diagram. The merge process may be carried out automatically based on a set of fixed rules and/or interactively by providing a graphical user interface for selecting the desired operation for each block and/or parameter separately.

In an embodiment of the invention, the technical computing environment is connected to a version control system, the version control system can include a database for saving block diagrams and corresponding intermediate forms, wherein opening a block diagram comprises retrieving the desired version of the block diagram from the version control system, and wherein after conversion of the block diagram, the intermediate form is saved in the version control system.

In an embodiment of the invention, before conversion of a block diagram, the current version of the block diagram and preferably the current version of the filter script is compared to the versions of intermediate forms saved in the version control system, and no conversion is performed if the current versions match the versions of the saved intermediate form. By reusing an existing intermediate form of a model, the comparison is accelerated. The version control system may be replaced by or combined with a data management system. For instance, a block diagram may be stored in the version control system, whereas the intermediate form corresponding to that block diagram may be stored in the data management system. This allows e.g. for improving the user experience by automating the handling of intermediate forms.

An aspect of the invention also relates to a non-transitory computer readable medium containing instructions that, when executed by a microprocessor of a computer system, cause the computer system to carry out the inventive method.

In a further aspect of the invention, a computer system is provided which comprises a processor, a random access memory, a graphics controller connected to a display, a serial interface connected to at least one human input device, and a nonvolatile memory, in particular a hard disk or a solid-state disk. The nonvolatile memory comprises instructions that, when executed by the processor, cause the computer system to carry out the inventive method.

The processor may be a general-purpose microprocessor that is customary used as the central processing unit of a personal computer or it may comprise one or a plurality of processing elements adapted for carrying out specific calculations, such as a graphics-processing unit. In alternative embodiments of the invention, the processor may be replaced or complemented by a programmable logic device, such as a field-programmable gate array, which is configured to provide a defined set of operations and/or may comprise an IP core microprocessor.

Further scope of applicability of the present invention will become apparent from the detailed description given hereinafter. However, it should be understood that the detailed description and specific examples, while indicating preferred embodiments of the invention, are given by way of illustration only, since various changes, combinations and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an exemplary diagram of a computer system;

FIG. 2 is an exemplary diagram of software components in a computer system;

FIG. 3 is a schematic diagram of an exemplary embodiment of the method;

FIG. 4 is a diagram of software components invoked by a method according to an embodiment of the invention;

FIG. 5 is a diagram of software components invoked by a method according to an embodiment of the invention;

FIG. 6A illustrates an embodiment of a graphical user interface for displaying differences between block diagrams showing an example of a comparison without filter scripts; and

FIG. 6B illustrates an embodiment of a graphical user interface for displaying differences between block diagrams showing an example of a comparison filtered with filter scripts according to the invention.

### DETAILED DESCRIPTION

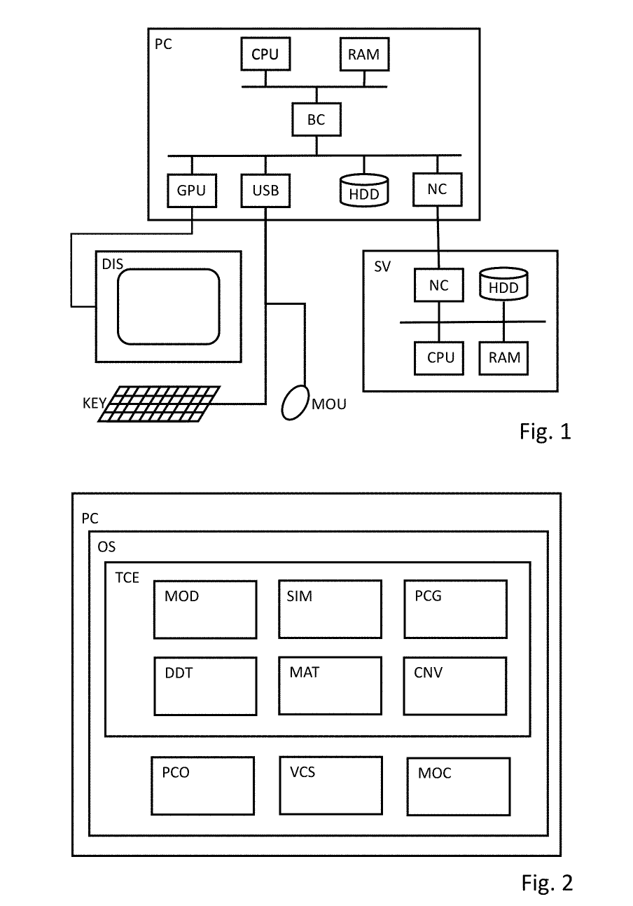

FIG. 1 illustrates an exemplary embodiment of a computer system. The shown embodiment comprises a host computer PC with a display DIS and human interface devices such as a keyboard KEY and a mouse MOU; further, an external server SV is depicted, which may execute one or more software components such as a database for storing block diagrams.

The host computer PC comprises at least one processor CPU with one or multiple cores, a random access memory RAM and a number of devices connected to a local bus (such as PCI Express), which exchange data with the CPU via a bus controller BC. The devices comprise e.g. a graphics-processing unit GPU for driving the display, a controller USB for attaching peripherals, a mass storage system HDD comprising one or more non-volatile memories such as a hard disk or a solid-state disk, and a network interface NC. Preferably, the non-volatile memory comprises instructions that, when executed by one or more cores of the processor CPU, cause the computer system to carry out an inventive method as defined by the appended claims.

The external server SV comprises a network interface NC, one or more processors CPU, a random access memory RAM and a mass storage system HDD comprising one or more non-volatile memories such as hard disks and/or solid state disks. Preferably, the embedded system ES is connected to the personal computer PC via the network interface NC. The connection may be via Ethernet, and it may comprise long-distance data transmissions. In general, the external server may not be necessary for carrying out the invention.

In alternative embodiments of the invention, the host computer may be realized in a client-server-setup comprising one or more external servers that are connected to a client comprising a display device and an input device via a network. Thus, in particular the technical computing environment may be executed partially or completely on the one or more external servers, such as in a cloud computing setup. A personal computer may be used as a client comprising a display device and an input device via a network. Alternatively, a graphical user interface of the technical computing environment may be displayed on a portable computing device, in particular a portable computing device with a touch screen interface or a virtual reality device.

FIG. 2 displays an exemplary embodiment of the software components being executed on a computer system, which may be realized as a host computer PC with a standard microprocessor that runs a standard operating system OS such as Microsoft Windows or a Linux distribution.

On the host computer PC, a technical computing environment TCE such as MATLAB/Simulink of The Mathworks may be installed. Other examples of technical computing environments comprise Labview of National Instruments or ASCET of ETAS. The technical computing environment TCE comprises a plurality of software components such as a modelling environment MOD, a simulation engine SIM, a mathematical and/or script interpreter MAT and a converter CNV. The TCE may comprise a production code generator PCG that is adapted to produce production code from a model; further, it may comprise a data definition tool DDT. The expression that a software component is comprised in the TCE is intended to encompass the case that the software component uses a specific mechanism of the TCE such as an application-programming interface of the TCE in order to exchange data and/or instructions with other software components in the TCE. For example, a software component may be realized as or comprise an add-on such as a toolbox for the modelling environment.

The modelling environment MOD may provide a graphical user interface for creating and modifying block diagrams that preferably describe the temporal behavior of a dynamic system. Additionally, blocks adapted for describing finite states of a statemachine (statechart) and conditions for transitions between states may be used to model the dynamic system. A block may describe an atomic operation, such as an arithmetic calculation or a logic expression, or it may represent a subsystem that is described in more detail by an additional block diagram in a subordinate hierarchical level. Alternatively, it may contain code in a higher-level programming language, in particular a dynamic language intended for mathematical programming, that realizes the block's functionality. Multiple blocks may be connected by signals for the exchange of data. For example, an initial block may receive a signal of type single as input signal, may modify the signal e.g. by adding a constant and may send an output signal of type double to a further block.

The simulation engine SIM may be adapted to execute a block diagram created in the modelling environment MOD in order to observe the temporal behavior of the dynamic system described by the block diagram. The execution of a block diagram may also be called a model-in-the-loop simulation of the dynamic system and is preferably carried out using high-precision operations in order to observe the behavior more closely and to create reference data.

The script interpreter MAT is adapted for carrying out calculations and/or modifying data. In addition to executing scripts, it may also contain a user interface for interactive calculations and modifications of data. In the environment of the script interpreter, parameters for one or more block diagrams may be set, saved and/or manipulated. The parameters may also influence the execution of the block diagram in the simulation engine.

A converter CNV allows for converting block diagrams to an intermediate form. The converter comprises a filtering mechanism by which a user may specify desired filter options via a filter script. Filter scripts allow for a very selective filtering in order to tailor the information extracted from the block diagram. As shown in the current example, the converter may be integrated in the technical computing environment. However, in alternative embodiments the converter may be integrated in a compare tool MOC or it may be realized as a stand-alone program.

The production code generator PCG may allow for creating production code from one or more blocks in a block diagram. Production code may be optimized for readability, traceability, safety, low-energy consumption, execution speed and/or memory requirements. Preferably, the code generator provides a user interface for setting a plurality of options for adapting the customization of the generated code. Customization options may include target-specific optimizations for the microcontroller of the embedded system and enforcing compliance of the generated code to a specific coding standard, such as the MISRA C guidelines. A particularly preferred production code generator PCG is TargetLink of dSPACE.

The Data Definition Tool DDT provides a database for storing definitions and parameters as well as an application-programming interface for automatic exchange of the data between different software components. This allows for a clean separation of the model of the dynamic system and/or the control strategy given in the block diagram from implementation-specific details stored in the database. When a complex model is structured in different sub-models, data in different sub-models may be linked. By storing corresponding information in the data definition tool, these dependencies may be automatically resolved. Additionally, by exchanging data with a software architecture tool, such as SystemDesk of dSPACE, the data definition tool DDT can be used as part of a higher-level tool chain, in particular to generate product code compliant to the AUTOSAR standard. A preferred data definition tool is TargetLink Data Dictionary of dSPACE.

Other software components such as a production code compiler PCO may also be installed on the host computer. These software components may be interfaced to each other and/or the technical computing environment using standard mechanisms of the underlying operating system OS. The compiler PCO may generate an executable for the microprocessor of the PC or it may generate an object code for the microcontroller of an embedded system.

Preferably, a version control system VCS is installed on the host computer. The version control system VCS may comprise a database of different versions of a block diagram. Further, it may also store intermediate representations created by the converter CNV.

On the host computer, a compare tool MOC is installed. The compare tool MOC allows for comparing different versions of a block diagram. Preferably, the MOC invokes the converter CNV to extract the desired information from the modeling environment MOD. Additionally, parameters may be extracted from the simulation engine SIM and/or from the data definition tool DDT. In alternative embodiments of the invention, the converter CNV may be integrated in the compare tool MOC.

One or more of the software components may be executed on external servers, realizing a client-server setup. For instance, the simulation engine may be executed on a first external server, and a version control system VCS comprising a database for different versions of a block diagram and/or corresponding intermediate representations may be executed on a second external server.

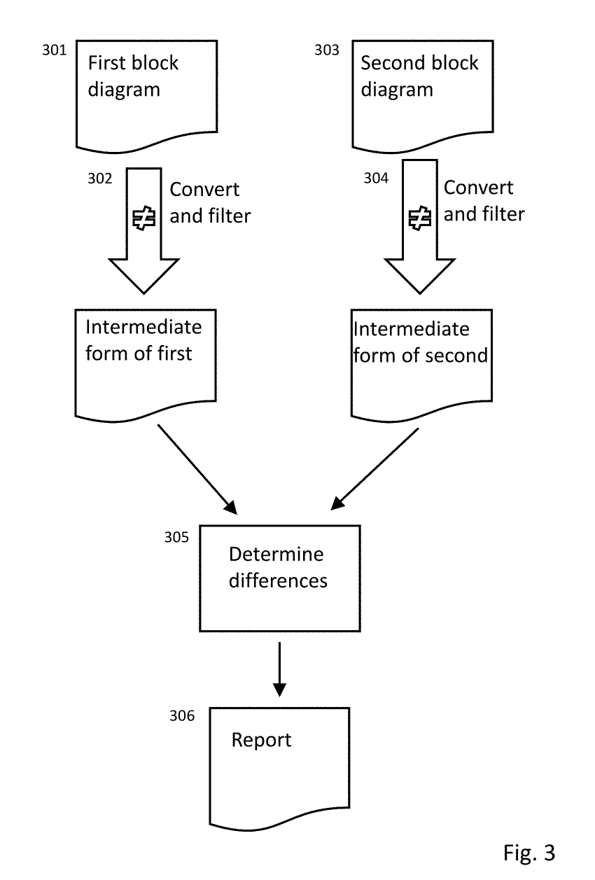

FIG. 3 illustrates an exemplary embodiment of an inventive method.

In step 301, a first block diagram is opened. Opening the first block diagram may comprise invoking the modelling environment MOD and/or the simulation engine SIM of the technical computing environment. Alternatively, a dedicated program for comparing models may be used. Opening the first block diagram may comprise loading a file containing this block diagram into the memory of the host computer.

In step 302, the first block diagram is converted to an intermediate form; the conversion comprises filtering the block diagram with at least one filter script. The resulting intermediate form of the first block diagram may be stored on a mass storage system of the computer. Preferably, the intermediate form comprises an indication of the filter scripts applied and/or the version of the filter scripts that were applied and/or a detailed indication of the modifications performed by the filter scripts.

In step 303, a second block diagram is opened. Opening the second block diagram may comprise invoking the modelling environment MOD and/or the simulation engine SIM of the technical computing environment. Alternatively, a dedicated program for comparing models may be used. Opening the second block diagram may comprise loading a file containing this block diagram into the memory of the host computer. Persons skilled in the art will notice that the sequence of some of the steps may be changed. When more than one block diagram can be open in the modeling environment or in the software component performing, both block diagrams may be opened before converting the block diagrams is started.

In step 304, the second block diagram is converted to an intermediate form; the conversion comprises filtering the block diagram with at least one filter script. The resulting intermediate form of the second block diagram may be stored on a mass storage system of the computer. Preferably, the intermediate form comprises an indication of the one or more filter scripts applied and/or the version of the filter scripts that were applied and/or a detailed indication of the modifications performed by the filter scripts.

In step 305, differences between the intermediate form of the first block diagram and the intermediate form of the second block diagram are determined. The software component for determining differences may be realized as a stand-alone executable and it may utilize a mechanism of the operating system or of the technical computing environment for receiving the intermediate forms of the block diagrams.

In step 306, the determined differences are outputted. Preferably, outputting the determined differences comprises generating a report, in particular a text file where differences are listed on at least a line per difference. The report may be shown on a display of the host computer and/or it may be stored on a mass storage system and/or it may be printed out using a printer. Other embodiments of the invention may show the determined differences on a display of the host computer without generating a text. Differences may also be shown graphically, in particular also indicating the element of the block diagram in which the respective difference occurred.

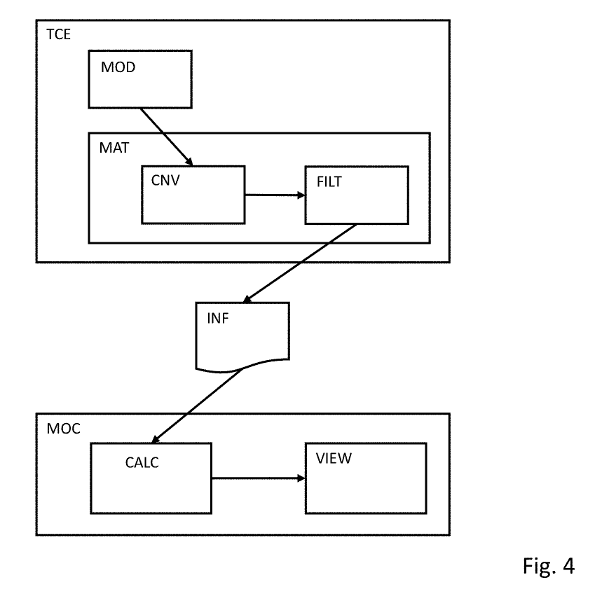

FIG. 4 displays software components invoked by a method according to a first preferred embodiment of the invention.

A block diagram (not shown in this figure) is opened in the modeling environment MOD, which may involve loading a file from a mass storage system to the random access memory of the host computer. Additionally, the simulation engine SIM and/or the data definition tool DDT may be invoked in order to determine values of parameters used for the block diagram.

The converter CNV accesses the information from the block diagram and transforms it into an intermediate form INF suitable for comparison. The conversion further comprises filtering the information via a filter script FILT. The order need not be fixed: The filter script FILT may be integrated in the conversion during any intermediate stage, or it may be executed before or after the rest of the conversion process. Further, more than one filter script may be applied during the conversion process.

Preferably, a first block diagram and a second block diagram are opened and converted subsequently, so that an intermediate form INF is generated for each block diagram.

The intermediate form INF may be saved as a file on a nonvolatile memory of the host computer; it may also be transferred directly between the technical computing environment TCE and the compare tool MOC, in particular using mechanisms of the operating system of the host computer.

The compare tool MOC comprises a determining module CALC for determining differences between the intermediate forms of the two block diagrams and an output module VIEW for outputting the determined differences. The output module VIEW may comprise a graphical user interface for selectively viewing one or more determined differences and/or viewing the elements of the block diagram, e.g. the blocks, where the differences occurred. Additionally or alternatively, the output module VIEW may generate a report, preferably a human-readable text file listing the differences found and the filter scripts applied. Additionally, a listing of the elements or parameters of the block diagram that were discarded from the intermediate form or modified during the conversion by the one or more filter scripts FILT may be included in the report.

In the shown example, all software components involved are either part of the technical computing environment TCE or of the compare tool MOC. Generally, one or more of the software components may also be in the form of a standalone executable file that is invoked using inter-application communication mechanisms of the operating system of the host computer. Alternatively, all of the software components used for executing the inventive method may be integrated in a single program.

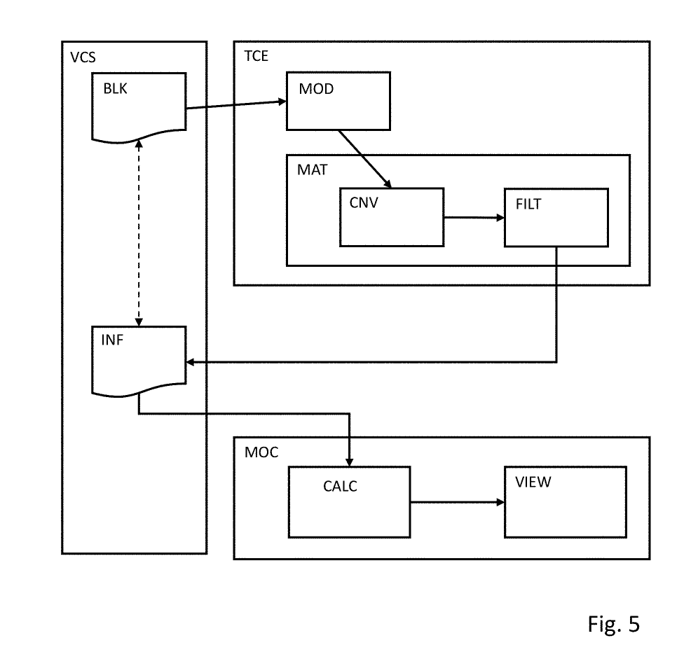

FIG. 5 illustrates the software components invoked by a method according to a second preferred embodiment of the invention. Most of the software components involved are similar to those in the embodiment of FIG. 4 and thus will not be described redundantly.

In this embodiment, opening a block diagram BLK involves retrieving the block diagram from a version control system VCS. Preferably, the version control system VCS stores block diagrams BLK with associated version information and/or a creation date and/or a modification date. As indicated by a dashed line, the version control system also stores an intermediate form INF of the block diagram BLK that is associated to a particular version of the model. Before the opened block diagram is converted to an intermediate form, the converter checks if a previously generated intermediate form INF corresponding to the current version of the current model exists in the version control system. When also the filter script is the same as in the previous conversion, i.e. the same modifications would be applied during converting the block diagram BLK, the converter CNV does not create a new intermediate form. The converter CNV preferably sends a signal to the compare tool MOC that comprises a link to the existing intermediate form INF or indicates the correct version of the block diagram BLK and any additional information needed for retrieving the correct intermediate form INF in the version control system VCS.

Reusing existing intermediate forms reduces the time needed for comparing models if at least one of the models is unchanged after a previous comparison. This is particularly useful when comparing currently changed models with models from a previous development iteration in the VCS.

The version control system VCS may be replaced by or combined with a data management system. For instance, the block diagrams may be stored in the version control system, whereas the intermediate forms and related information may be stored in the data management system. A particularly preferred example of a data management system is SYNECT of dSPACE. By combining a version control system with a data management system, the handling of the intermediate forms corresponding to different versions of a block diagram may become transparent for the user because different intermediate forms or different versions of intermediate forms need not be checked in explicitly but will be dealt with by the data management system.

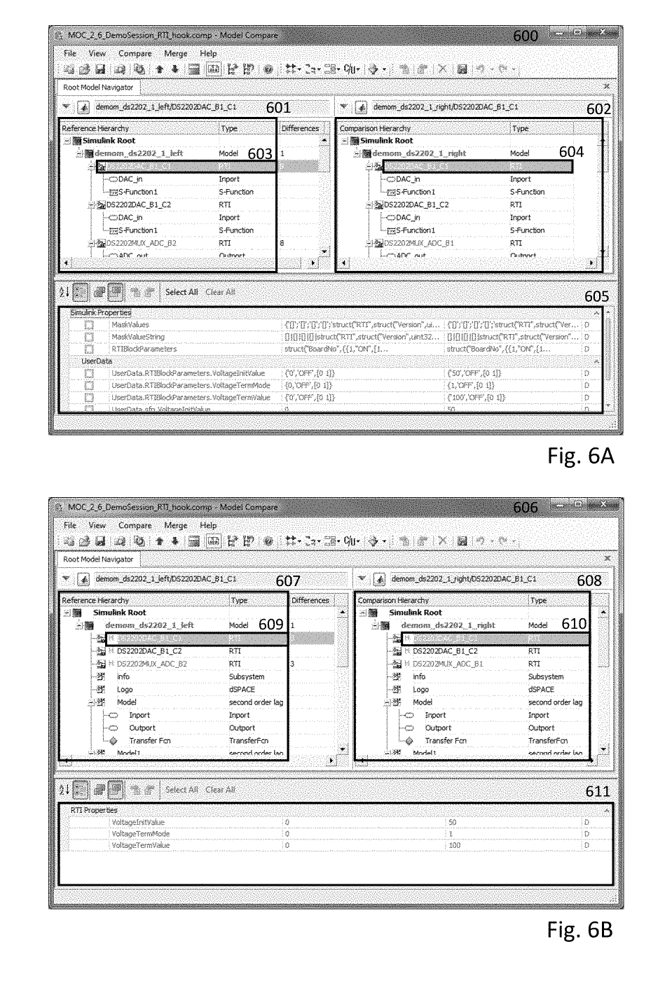

FIG. 6A depicts an embodiment of a graphical user interface for displaying differences between block diagrams showing an example of a comparison without filter scripts.

In the figure, a main window 600 of the compare tool MOC is shown comprising a menu and a row of symbols for invoking different components of the compare tool MOC or changing different settings of the program. Below, tree views of the compared block diagrams are displayed side-by-side: To the left, a tree view 601 of the first block diagram, and to the right, a tree view of the second block diagram 602. Each tree view comprises a list of the blocks in the block diagram and it may comprise a list of the sub-elements of the blocks (if the view is expanded). In the left tree view 601, a block 603 of the first block diagram is selected. In the right tree view 602, a block 604 in the second block diagram is selected. At the bottom, a list of differences 605 between the selected block is displayed.

Because the intermediate forms of the first and the second block diagram were not filtered using a filter script, the number of differences is large, and the user would have to scroll down the list in order to find a specific difference. In addition, the block properties and their values in the detailed difference list 605 of blocks are also unfiltered, which makes it similar difficult to distinguish relevant from non-relevant information here.

FIG. 6B illustrates an embodiment of a graphical user interface for displaying differences between block diagrams showing an example of a comparison with applied filter scripts according to the invention.

This figure also depicts a main window 606 of the compare tool MOC with a menu and a row of symbols. Below, a tree view 607 of the first block diagram is shown to the left, and a tree view 608 of the second block diagram is shown to the right. A block 609 of the first block diagram and a block 610 of the second block diagram are selected. In the tree views 607 and 608, elements of the block diagram that have been handled by a filter script, e.g. the block “DS2202DAC_B1_C1”, are indicated by the letter “H”. In the shown example, sub-elements of the blocks have been suppressed by the filter script.

At the bottom, a list of differences 611 between the first and the second block diagram is displayed. The filter script applied during the conversion performed a selection of the block properties. This may e.g. have comprised selecting a category of block properties to be considered or filtering according to a regular expression. Additionally, the way selected parameters are displayed was adapted. A user can immediately see that e.g. the parameter “VoltageInitValue” has a value of “0” in the first block diagram and a value of “50” in the second block diagram.

By filtering the intermediate form of the block diagrams according to the invention, the user can easily discern the relevant differences. This allows for faster modification cycles to the block diagrams and thus for an accelerated development of control strategies for ECUs.

While the present invention has been described with respect to a limited number of embodiments, those skilled in the art will appreciate numerous modifications and variations therefrom. It is intended that the appended claims cover all such modifications and variations as fall within the true spirit and scope of the present invention.

One possible variation is to apply the described invention also in a three-way compare/merge scenario, where a third block diagram (common ancestor model) is used to refine the comparison of the first and second block diagrams which both evolved from this third diagram (possibly changed by different persons in parallel). Then by merging a fourth block diagram is created that combines the changes from the first block diagram and the second block diagram. Preferably the user indicates which version of the respective difference to retain in order for the fourth block diagram to become the union of the two and thus a new base for future iterations. The mechanisms described above may have been applied to the third block diagram correspondingly.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for comparing block diagrams, the block diagrams describing a temporal evolution and/or internal states of a dynamic system in a technical computing environment on a host computer, wherein a block in the block diagram comprises input ports for receiving signals and output ports for sending signals, the method being carried out by a processor of the host computer, the method comprising:
opening a first block diagram;
converting the first block diagram to an intermediate form, the conversion comprising filtering using a filter script;
opening a second block diagram;
converting the second block diagram to an intermediate form, the conversion comprising filtering using a filter script;
determining existing differences between the intermediate form of the first block diagram and the intermediate form of the second block diagram; and
outputting the determined differences.

2. The method of claim 1, wherein filtering using a filter script comprises discarding at least one block and/or at least one parameter of a block diagram, so that the block and/or the parameter are not present in the intermediate form of the block diagram.

3. The method of claim 2, wherein outputting the determined differences comprises outputting an indication of the filter scripts used for filtering and/or an indication of a version of the filter scripts used for filtering and/or an indication of the applied rules or modifications.

4. The method of claim 1, wherein the technical computing environment comprises a modeling environment and a script interpreter, wherein opening a block diagram comprises invoking the modeling environment of the technical computing environment, and wherein filtering a block diagram using a filter script comprises executing the filter script in the script interpreter of the technical computing environment.

5. The method of claim 4, wherein the intermediate form of a block diagram is a file in a markup language that comprises information on the blocks and the signals in the block diagram, wherein converting a block diagram comprises evaluating the value of at least one parameter in the modeling environment and/or the script interpreter, and wherein the intermediate form of the block diagram also comprises the value of the at least one parameter.

6. The method of claim 1, wherein a block diagram comprises multiple hierarchical levels, wherein at least one block in a first hierarchical level is implemented using a plurality of blocks in a second hierarchical level, wherein the second hierarchical level is below the first hierarchical level or directly below the first hierarchical level, and wherein filtering using a filter script comprises selecting a hierarchical level and/or limiting the number of hierarchical levels which are converted in the intermediate form.

7. The method of claim 6, wherein blocks in the first hierarchical level are kept and blocks in the second hierarchical level are discarded when filtering the block diagram using a filter script.

8. The method of claim 1, wherein outputting the determined differences comprises displaying a graphical diagram and/or at least one line of text containing at least some of the determined differences, and wherein the outputting is performed using a display and/or a network interface and/or a storage medium of the host computer.

9. The method of claim 1, further comprising copying at least one block from the first block diagram to the second block diagram based on the determined differences and/or deleting at least one block from the second block diagram based on the determined differences.

10. The method of claim 1, wherein the technical computing environment is connected to a version control system, the version control system comprising a database for saving block diagrams and corresponding intermediate forms, wherein opening a block diagram comprises retrieving the desired version of the block diagram from the version control system, and wherein after conversion of the block diagram, the intermediate form is saved in the version control system.

11. The method of claim 10, wherein before conversion of a block diagram, the current version of the block diagram and the current version of the filter script is compared to the versions of intermediate forms saved in the version control system, and wherein no conversion is performed if the current versions match the versions of the saved intermediate form.

12. A non-transitory computer readable medium containing instructions that, when executed by a processor of a computer system, cause the computer system to carry out the method according to claim 1.

13. Computer system, comprising a processor, a random access memory, a graphics controller connected to a display, a serial interface connected to at least one human input device, and a nonvolatile memory, a hard disk or solid state disk, the nonvolatile memory comprising instructions that, when executed by the processor, cause the computer system to carry out the method according to claim 1.
